(19) United States
(12) Patent Application Publication
(10) Pub. No.: US 2007/0233502 A1
(43) Pub. Date: Oct. 4, 2007

(54) Integrated management system for greenhouse gas projects

(76) Inventors: Randall Ray Richards, Chillicothe, IL (US); James Edward Chapman, Washington, IL (US); Noel Joy Rytter, Dunlap, IL (US); Morton Herman Sill JR., Chillicothe, IL (US); Stephen John Pierz, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/392,682

(22) Filed: Mar. 30, 2006

(51) Int. Cl. G06Q 99/00

(52) U.S. Cl. 705/1

(57) ABSTRACT

A system for managing greenhouse gas-related activities includes a management system communicatively coupled to a greenhouse gas facility and configured to collect and distribute operation data associated with operations of the greenhouse gas facility. The system also includes at least one subscriber communicatively coupled to the management system. The subscriber is configured to analyze the received operation data based on at least one characteristic of a greenhouse gas project environment. The subscriber is also configured to provide one or more recommendations for adjusting an operational aspect associated with the greenhouse gas facility based on the analysis. The management system adjusts one or more operational aspects associated with the greenhouse gas facility based on the recommendations provided by the subscriber.

### TECHNICAL FIELD

The present disclosure relates generally to greenhouse gas reduction projects and, more particularly, to systems and methods for managing greenhouse gas projects.

### BACKGROUND

Greenhouse gas emissions have become a topic of concern for many in the international community. Some studies suggest that there may be a correlation between greenhouse gas emissions and long-term climate change. In an effort to address these concerns, many countries have ratified the Kyoto Protocol, accepting provisions that impose limits on (and in many cases calls for reductions in) the amount of greenhouse gas emissions associated with each member country. In order to meet the provisions of the Kyoto Protocol, some governments of these member countries have enacted legislation that imposes emission limitations on facilities operating within the respective country. In many cases, organizations associated with facilities that exceed these limitations may face economic penalties, such as fines, work stoppages, tax increases, etc. Thus, the economic incentives for organizations to comply with greenhouse gas emission restrictions may be significant.

One way for organizations to meet their emission reduction targets is through the purchase of excess greenhouse gas credits generated by entities that have met their target emission reductions and subsequently engaged in greenhouse gas generating activities. These credits may be purchased directly from these entities or publicly via a greenhouse gas trading market. As more companies look to purchase greenhouse gas credits to meet their emission reduction targets, the demand for greenhouse gas credits may increase significantly.

In order to meet this demand, greenhouse gas credit generation systems may be implemented. These systems generate greenhouse gas credits by reducing or mitigating the effects of greenhouse gas emissions using various techniques such as, for example, through greenhouse gas sequestration, greenhouse gas capture, greenhouse gas storage, etc. These systems may be deployed and/or implemented in locations where greenhouse gas emissions are prevalent, such as landfill sites, mine sites, and/or agricultural environments. In order to efficiently oversee operations of these facilities, a system for efficiently managing a greenhouse gas project environment may be required.

At least one system has been developed for managing environmental programs. For example, U.S. Patent Publication No. 2006/0015424(“the '424publication”) to Esposito II, et al. describes a computerized emission analysis system. This system may receive entity emission information input by a user and analyze the information in order to generate emission management portfolios, schedule emission management activities, and project future emission estimates. The system may also compare the emission information to regulatory criteria and determine if the emissions meet the requirements to qualify for allowances and/or credits.

Although the system of the '424publication may provide certain emission management capabilities, it may still be inadequate. For example, the system of the '424publication only provides analysis and recommendation reporting based on certain user-supplied information. The system does not, however, collect real-time operation data associated with a facility and adjust operations of the facility based on the collected data.

Moreover, because the system of the '424publication does not collect real-time data from an emission entity, it may be inefficient. For example, certain operations and conditions associated with the entity may require a timely response. However, because the '424publication is only configured to receive input entered by a user, there may be a time lag between when the data was collected and when the user entered the data. Consequently, the resulting analysis may be inaccurate and/or outdated. As a result, systems that rely on real-time data monitoring and management capabilities may become inefficient.

The presently disclosed system and associated method for managing greenhouse gas-related projects are directed toward overcoming one or more of the problems set forth above.

### SUMMARY OF THE INVENTION

In accordance with one aspect, the present disclosure is directed toward a system for managing greenhouse gas-related activities. The system may include a management system communicatively coupled to a greenhouse gas facility. The management system may be configured to collect and distribute operation data associated with operations of the greenhouse gas facility. The system may also include at least one subscriber communicatively coupled to the management system. The subscriber may be configured to analyze the received operation data based on at least one characteristic of a greenhouse gas project environment. The subscriber may also be configured to provide one or more recommendations for adjusting an operational aspect associated with the greenhouse gas facility based on the analysis. The management system may adjust one or more operational aspects associated with the greenhouse gas facility based on the recommendations provided by the subscriber.

According to another aspect, the present disclosure is directed toward a method for managing a greenhouse gas reduction project. The method may include receiving operation data indicative of a performance of a greenhouse gas reduction project. The method may also include monitoring one or more characteristics associated with a greenhouse gas project environment. The method may further include analyzing the received operation data associated with the greenhouse gas reduction project based on the monitored characteristics. The method may also include providing recommendations for adjusting one or more operational aspects associated with the greenhouse gas reduction project based on the analysis. The method may further include adjusting the one or more operational aspects associated with the greenhouse gas reduction project based on an analysis of the recommendations.

In accordance with yet another aspect, the present disclosure is directed toward a greenhouse gas project environment. The project environment may include one or more greenhouse gas facilities. Each greenhouse gas facility may be configured to collect a greenhouse gas and convert the collected greenhouse gas into a second greenhouse gas and a conversion product, wherein the second greenhouse gas has a lower global warming potential than the first greenhouse gas. The greenhouse gas facility may also determine an amount of greenhouse gas credits based on a global warming potential reduction associated with the conversion. The project environment may further include a management system operatively coupled to each of the one or more greenhouse gas facilities. The management system may be configured to collect operation data associated with the performance of each of the one or more greenhouse gas facilities. The management system may also be configured to monitor one or more characteristics associated with the greenhouse gas project environment. The management system may be further configured to analyze the collected operation data based on the one or more characteristics. The management system may also be configured to adjust an operational aspect associated with one or more of the greenhouse gas facilities based on the analysis.

According to yet another aspect, the present disclosure is directed toward a greenhouse gas project management system. The system may include an interface and a central processing unit communicatively coupled to the interface. The central processing unit may be configured to receive, via the interface, operation data associated with the performance of each of the one or more greenhouse gas facilities. The central processing unit may also be configured to monitor one or more characteristics associated with the greenhouse gas project environment. The central processing unit may be further configured to analyze the collected operation data based on the one or more characteristics. The central processing unit may also be configured to adjust an operational aspect associated with one or more of the greenhouse gas facilities based on the analysis.

### BRIEF DESCRIPTION OF THE DRAWINGS

FIG. 1 illustrates an exemplary greenhouse gas project environment consistent with certain disclosed embodiments;

FIG. 2 illustrates an exemplary management system associated with the project environment illustrated in FIG. 1; and

FIG. 3 provides a flowchart of an exemplary method for managing a greenhouse gas project.

### DETAILED DESCRIPTION

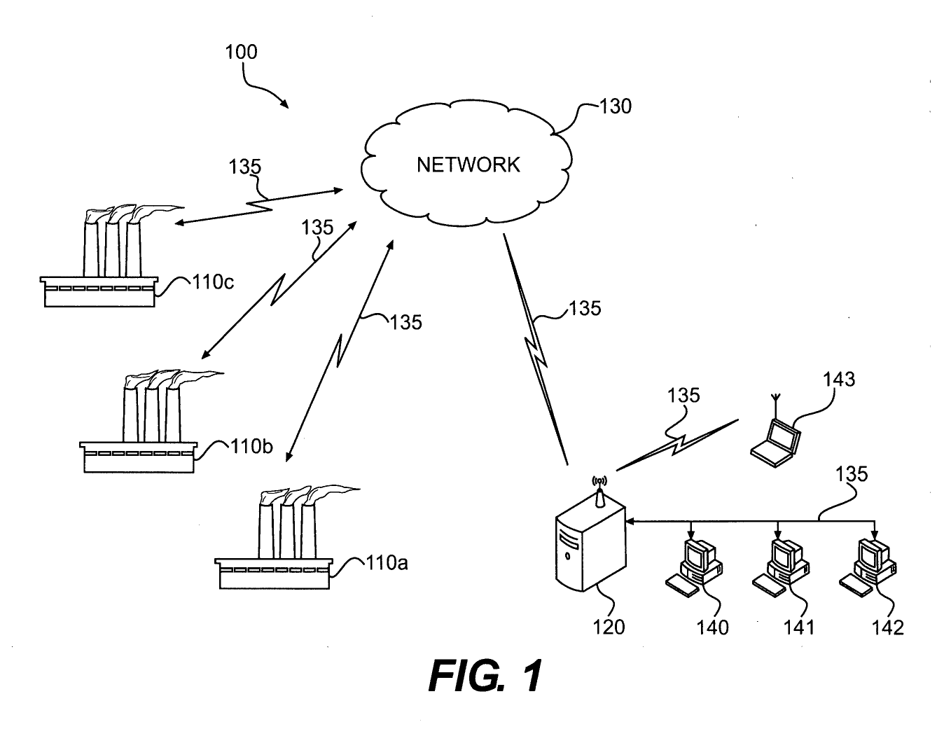

FIG. 1 illustrates an exemplary greenhouse gas project environment 100, consistent with certain disclosed embodiments. Greenhouse gas project environment 100 may include any environment related to the collection, generation, production, processing, conversion, destruction, and/or storage of greenhouse gas. Greenhouse gas project environment 100 may include, for example, one or more facilities for reducing or mitigating the effects of emissions of greenhouse gas into the atmosphere; one or more facilities for generating greenhouse gas credits; one or more greenhouse gas trading markets; one or more greenhouse gas product markets; one or more locations where potential greenhouse gas projects may be implemented (i.e., landfill sites, biomass sites, agricultural sites, etc.); a greenhouse gas credit storage entity; one or more equipment dealers; manufacturing and/or rental facilities; a product storage entity; or any other suitable facility, device, or system. It is contemplated that greenhouse gas project environment 100 may include elements that are shared among several other greenhouse gas project environments, such as a trading or sale markets.

Greenhouse gas project environment 100 may include one or more components and systems that may cooperate to monitor, control, and/or facilitate the performance of a greenhouse gas conversion project. For example, greenhouse gas project environment 100 may include one or more subsystems configured to monitor, collect, and record data associated with operations of existing greenhouse gas reduction projects. Alternatively and/or additionally, the project environment may include one or more subsystems configured to facilitate implementation of future greenhouse gas reduction projects. The project environment may also include one or more subsystems configured to manage the collection, distribution, and sale of products associated with a greenhouse gas reduction activity. Products, as the term is used herein, may include any product generated or produced in connection with greenhouse gas reduction projects. For example, products may include one or more greenhouse gas credits; electricity generated by a greenhouse gas combustion process; substances such as hydrogen, steam, etc. resulting from chemical conversion processes; materials packaged and transacted with greenhouse gas credits; or any other suitable product associated with a greenhouse gas reduction project. As illustrated in FIG. 1, greenhouse gas project environment 100 may include, among other things, one or more greenhouse gas facilities 110a-c, a management system 120, and a communication network 130. Greenhouse gas project environment 100 may include additional, fewer, and/or different components than those listed above.

Greenhouse gas facilities 110a-c may each include one or more systems configured to perform processes that may mitigate and/or reduce an amount carbon dioxide equivalent (CO₂e) emissions of a greenhouse gas source. Greenhouse gas facilities 110a-c may be configured to collect and/or extract greenhouse gas from one or more greenhouse gas sources. Once collected, the greenhouse gas may be stored, processed, and/or converted to limit the emission of CO₂e gases into the atmosphere—activities which may result in the issuance of greenhouse gas emission reduction credits. Certain conversion processes may also generate products that may be distributed with greenhouse gas emission credits and/or sold separately.

Greenhouse gas facility 110a-c may include one or more components and/or subsystems configured to reduce a global warming potential (GWP) associated with an emission of greenhouse gas from a facility. GWP, as the term is used herein, refers to a measure of the relative impact that a given mass of greenhouse gas is estimated to contribute to global warming, as established by the Intergovernmental Panel on Climate Change (IPCC). The GWP of a particular greenhouse gas is a measure of comparison of the mass associated with the greenhouse gas with the same mass of carbon dioxide (CO₂) (with a defined GWP of 1). The GWP is calculated over a particular time interval, as different gases have different effects on the environment over time. In general, unless otherwise specified, the time period used for calculations involving GWP is 100 years. Thus, the GWP for methane (CH₄) determined on a 100-year time horizon is 23 (i.e., one metric ton of methane emitted into the atmosphere is equivalent to 23 metric tons of carbon dioxide emission).

For example, a first greenhouse gas facility 110a may include a methane capture and conversion facility that captures methane gas from one or more sources (e.g., landfills, coal beds, biomass, agricultural matter, etc.). First greenhouse gas facility 110a may burn the methane in a combustion process to convert the methane into carbon dioxide, potentially generating greenhouse gas credits. These credits may be sold, traded, and/or applied toward reducing a C0₂e emission target. The reduction facility may also be configured to harness the thermal energy from the combustion to generate electricity, which may also be sold to generate additional revenue.

According to another embodiment, a second greenhouse gas facility 110b may include a methane capture and conversion facility that combines the methane with water in a steam reformation process, producing carbon dioxide and hydrogen. This process may result in the generation of greenhouse gas credits from the conversion of methane to carbon dioxide. The reduction facility may also be configured to capture hydrogen gas produced by the conversion process and store the gas for sale, distribution, and/or use as fuel in hydrogen vehicles.

In accordance with another embodiment, a third greenhouse gas facility 110c may include a methane capture facility that flares methane accumulated in a subterranean source, thereby converting the methane to carbon dioxide and potentially generating greenhouse gas credits. This conversion may be employed in situations where the level, location, and/or source of methane may not be conducive to high volume conversion and by-product production, such as, for example, when methane levels in a landfill drop below a certain concentration. However, these facilities may still be eligible for greenhouse gas credits resulting from the methane combustion process.

Communication network 130 may include a networking platform that facilitates communications and data sharing between one or more components and systems associated with greenhouse gas project environment 100. For example, communication network 130 may include one or more broadband communication platforms that may communicatively couple one or more greenhouse gas facilities 110a-c with management system 120. These platforms may include, for example, cellular, Bluetooth, microwave, point-to-point wireless, point-to-multipoint wireless, multipoint-to-multipoint wireless, LAN, WAN (e.g., the Internet), Ethernet, or any other appropriate communication platform for networking a number of components.

Each component and/or system associated with greenhouse gas project environment 100 may be communicatively coupled to network 130 via communication links 135. For example, greenhouse gas facilities 110a-c and management system 120 may each be coupled to communication network 130 via communication links 135. Communication links 135 may include a wireless link such as, for example, a satellite communication system, a cellular, a Bluetooth, a microwave, a point-to-point wireless, a point-to-multipoint wireless, a multipoint-to-multipoint wireless, or any other appropriate communication platform for networking a number of components. Alternatively and/or additionally, communication links 135 may include wireline links such as, for example, Ethernet, fiber optic, waveguide, or any other type of wired communication network.

Management system 120 may include one or more subscribers 140-143 that may each include one or more software and/or hardware components configured to collect, monitor, record, and analyze information associated with certain aspects and/or characteristics associated with greenhouse gas project environment 100. Although subscribers 140-143 are illustrated as standalone systems with respect to management system 120, it is contemplated that subscribers 140-143 may be separate systems integrated within management system 120. For example, subscribers 140-143 may include separate software elements within management system 120 that each monitor particular aspects of greenhouse gas project environment 100.

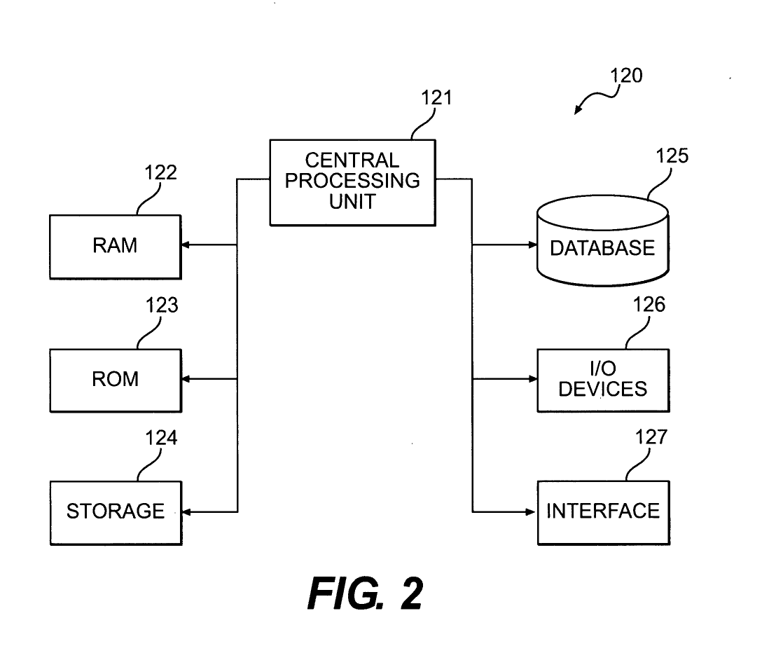

Management system 120 may include a computer system configured to receive, monitor, analyze, store, and distribute information associated with greenhouse gas project environment 100. As shown in FIG. 2, management system 120 may include one or more hardware and/or software components configured to collect, monitor, store, analyze, evaluate, distribute, report, process, record, and/or sort information associated with a proposed sale of greenhouse gas credits. For example, management system 120 may include one or more hardware components such as, for example, a central processing unit (CPU) 121, a random access memory (RAM) module 122, a read-only memory (ROM) module 123, a storage 124, a database 125, one or more input/output (I/O) devices 126, and an interface 127. Alternatively and/or additionally, management system 120 may include one or more software components such as, for example, a computer-readable medium including computer-executable instructions for performing methods associated with the management of a greenhouse gas project. It is contemplated that one or more of the hardware components listed above may be implemented using software. For example, storage 124 may include a software partition associated with one or more other hardware components of management system 120. Management system 120 may include additional, fewer, and/or different components than those listed above. It is understood that the components listed above are exemplary only and not intended to be limiting.

CPU 121 may include one or more processors, each configured to execute instructions and process data to perform functions associated with greenhouse gas project environment 100. As illustrated in FIG. 2, CPU 121 may be communicatively coupled to RAM 122, ROM 123, storage 124, database 125, I/O devices 126, and interface 127. CPU 121 may be configured to execute sequences of computer program instructions to perform various processes, which will be described in detail below. The computer program instructions may be loaded into RAM for execution by CPU 121.

RAM 122 and ROM 123 may each include one or more devices for storing information associated with greenhouse gas project environment 100 and/or CPU 121. For example, ROM 123 may include a memory device configured to access and store information associated with greenhouse gas project environment 100, including information for identifying, initializing, and monitoring the operation of one or more components and subsystems of greenhouse gas project environment 100. RAM 122 may include a memory device for storing data associated with one or more operations of CPU 121. For example, ROM 123 may load instructions into RAM 122 for execution by CPU 121.

Storage 124 may include any type of mass storage device configured to store any type of information that CPU 121 may need to perform processes consistent with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that store, organize, sort, filter, and/or arrange data used by management system 120 and/or CPU 121. For example, database 125 may store one or more predetermined target quantities of greenhouse gas credits associated with one or more greenhouse gas facilities. Database 125 may also store one or more threshold levels associated with one or more operational aspects of greenhouse gas project environment such as, for example, a threshold level indicative of an overload condition associated with one or more greenhouse gas conversion facilities 110a-c. It is contemplated that database 125 may store additional and/or different information than that listed above.

Input/Output (I/O) devices 126 may include one or more components configured to communicate information with a user associated with management system 120. For example, I/O devices 126 may include a console with an integrated keyboard and mouse to allow a user to input parameters associated with management system 120. I/O devices 126 may also include a display including a graphical user interface (GUI) for outputting information on a monitor. I/O devices 126 may also include peripheral devices such as, for example, a printer for printing information associated with management system 120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 127 may include one or more components configured to transmit and receive data via communication network 130, such as the Internet, a local area network, a workstation peer-to-peer network, a direct link network, a wireless network, or any other suitable communication platform. For example, interface 127 may include one or more modulators, demodulators, multiplexers, demultiplexers, network communication devices, wireless devices, antennas, modems, and any other type of device configured to enable data communication via any suitable communication network.

The disclosed method and system may provide a mechanism for efficiently managing aspects of greenhouse gas project environment 100. In particular, the disclosed management system 120 and method may by employed to collect operation data associated with operations of a greenhouse gas facility, analyze the operation data with respect to various characteristics of the project environment, and adjust an operational aspect associated with the project environment. According to certain embodiments, recommendations for performing future greenhouse gas projects may be provided based on the operation data and project environment characteristics.

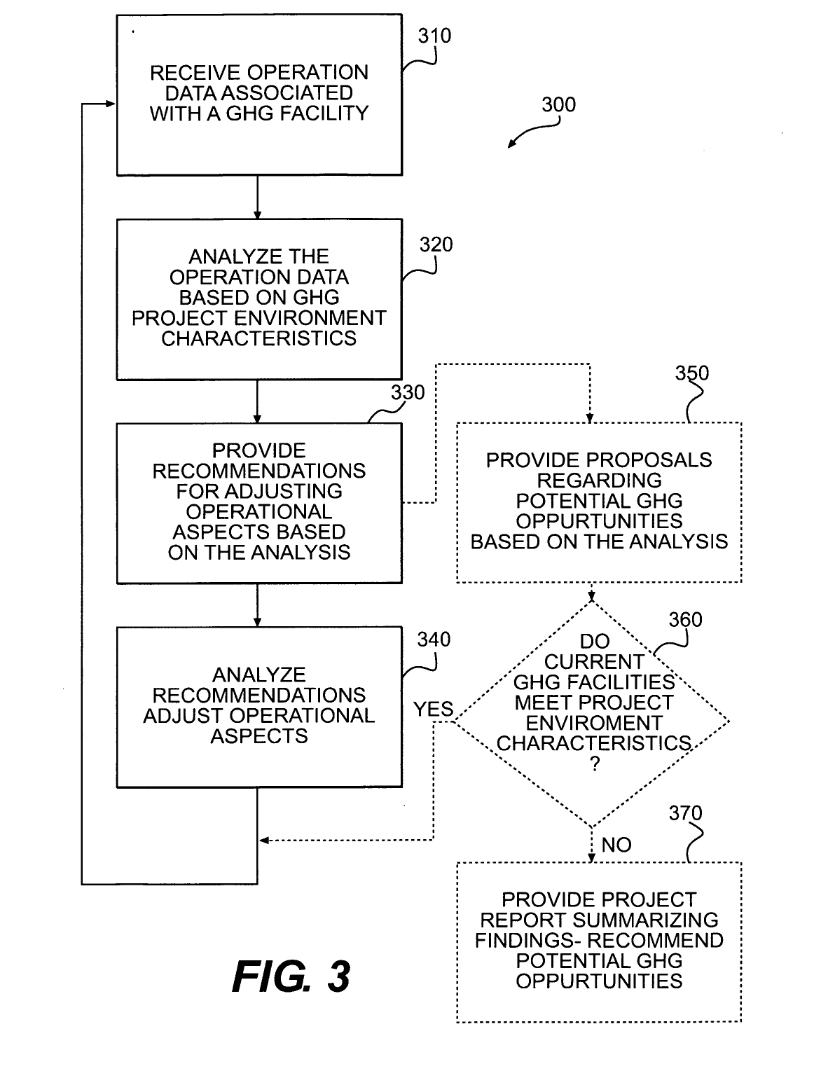

FIG. 3 illustrates a flowchart 300 depicting an exemplary method that utilizes management system 120 to manage a greenhouse gas project based on the performance of one or more greenhouse gas facilities 110a-c and certain characteristics associated with greenhouse gas project environment 100. It is contemplated that, although aspects of the method are described as being performed by management system 120, certain aspects of the method may be performed manually, for example, by a project manager associated with greenhouse gas project environment 100.

As illustrated in FIG. 3, managing a greenhouse gas project may include receiving operation data associated with greenhouse gas facilities 110a-c (Step 310). For example, management system 120 may receive operation data during real-time operation of greenhouse gas facilities 110a-c. This data may be received automatically from each of greenhouse gas facilities 110a-c, either continuously or periodically, during operation of each respective facility. Alternatively, management system 120 may transmit a data query to one or more greenhouse gas facilities 110a-c. Operation data may be received from the one or more greenhouse gas facilities 110a-c in response to the data query.

For purposes of the present disclosure, operation data may include any information associated with a greenhouse gas facility such as, for example, health or status information associated with the facility or facility subsystem; a productivity (e.g., quantity of greenhouse gas credits generated, amount of greenhouse gas product(s) produced, hours of operation, etc.); greenhouse gas conversion data associated with a conversion process (e.g., amount of methane consumed/hour, amount of carbon dioxide produced/hour, etc.); a production capacity (e.g., greenhouse gas credits produced vs. greenhouse gas credits production capability, product yield vs. product production capacity, etc.); or any other information indicative of operations associated with a greenhouse gas facility.

Once operation data has been received, the data may be analyzed based on one or more greenhouse gas project environment characteristics (Step 320). Greenhouse gas project environment characteristics may include any information associated with greenhouse gas project environment 100 such as, for example, current and/or historic price data associated with a greenhouse gas credit trading market; current and/or historic price data associated with a greenhouse gas product market (e.g., electricity, hydrogen gas, etc.); one or more aspects associated with a potential greenhouse gas project (e.g., construction and implementation costs associated with a prospective greenhouse gas facility, a land cost associated with a prospective greenhouse gas facility, an estimated amount of greenhouse gas credits that may be generated by the proposed facility); or any other suitable characteristic associated with greenhouse gas project environment 100.

These characteristics may be monitored by management system 120 or, alternatively, by subscribers 140-143 and used as a baseline for analysis of the received operation data. For example, one or more of management system 120 and/or subscribers 140-143 may be communicatively coupled to one or more external resources, such as greenhouse gas credit trading markets, commodity markets, landfill acquisition markets, etc. Alternatively and/or additionally, one or more of management system 120 and/or subscribers 140-143 may be in communication with internal resources such as, for example, greenhouse gas credit accounting systems, greenhouse gas product accounting systems, greenhouse gas credit and/or product order systems. Management system 120 and/or subscribers 140-143 may be configured to monitor these external and internal sources, collect greenhouse gas project environment characteristics from the appropriate source, and analyze the operation data with respect to these characteristics.

As previously explained, one or more subscribers 140-143 may embody separate systems integrated within management system 120. Alternatively, one or more subscribers may embody standalone systems communicatively coupled to management system 120 via communication links 135. Subscribers 140-143 may each correspond to a particular division or business unit responsible for monitoring certain greenhouse gas project environment characteristics, one or more of which may be located remotely from management system 120. For example, subscriber 140 may correspond to a sales and marketing business unit in communication with one or more greenhouse gas credit trading markets. Accordingly, subscriber 140 may be configured to monitor characteristics associated with a fair market price of greenhouse gas credits. Alternatively and/or additionally, sales and marketing subscriber 140 may be in communication with one or more commodity markets and configured to monitor characteristics associated with a fair market price of products produced by one or more greenhouse gas facilities 110a-c. Subscriber 140 may be configured to analyze the received operation data based on the monitored sales and marketing characteristics associated with the greenhouse gas project environment 100.

According to another embodiment, a subscriber 141 corresponding to an accounting business unit may be configured to collect, monitor, and store information related to a balance of greenhouse gas credits and products accumulated by greenhouse gas facilities 110a-c. Subscriber 141 may track balances of validated greenhouse gas credits and/or products associated with each of greenhouse gas facilities 110a-c. Alternatively and/or additionally, accounting subscriber 141 may be configured to monitor greenhouse gas credit and product orders and allocate the necessary quantities to satisfy the orders. Accordingly, subscriber 141 may be configured to analyze the received operation data based on the accounting characteristics associated with the greenhouse gas project environment 100.

According to yet another embodiment, a subscriber 143 corresponding to a project development business unit may be configured to monitor various aspects associated with potential greenhouse gas projects. For example, subscriber 143 may monitor methane levels at one or more mine sites and determine when the methane level reaches an appropriate concentration to justify construction of a methane collection and conversion facility. Alternatively, subscriber 143 may monitor methane levels and land values as various landfill sites. Subscriber 143 may determine when the methane level and/or land value justifies a potential acquisition of the landfill site. Subscriber 143 may be configured to analyze the received operation data based on one or more project development characteristics associated with the greenhouse gas project environment 100.

Once the operation data has been analyzed with respect to appropriate project environment characteristics, recommendations may be provided for adjusting one or more operational aspects associated with greenhouse gas project environment 100 (Step 330). For example, subscribers 140-143 may each provide recommendations for adjusting a operational aspect of one or more greenhouse gas facilities 110a-c associated with greenhouse gas project environment 100 based on an analysis performed by the respective subscriber.

For example, sales and marketing subscriber 141 may monitor historic trends related to the fair market value of greenhouse gas credits to determine peak price periods (corresponding to increased demand) associated with the credits. Based on the anticipated increase in prices, sales and marketing subscriber 141 may provide a recommendation to management system 120 to increase the production of greenhouse gas credits by increasing a conversion rate associated with each of greenhouse gas facilities 110a-c.

Similarly, accounting subscriber 142 may monitor greenhouse gas credit and product balances while filling orders received from customer. Should one or more of the greenhouse gas credit and product balances fall below a minimum threshold level, accounting subscriber 142 may provide a recommendation to management system 120 to increase the productivity of one or more of greenhouse gas facilities 110a-c, by increasing the conversion rate of the respective facility.

It is contemplated that each of subscribers 140-143 may prioritize the recommendations based on one or more predetermined criteria. For example, sales and marketing subscriber 140a may assign priority for a recommendation to increase the production of greenhouse gas credits based on a degree with which the price of the greenhouse gas credits is estimated to increase. Thus, recommendations corresponding to nominal increases may be assigned a low priority, while those recommendations corresponding to substantial increases may warrant a high priority.

Once the recommendations for adjusting one or more operational aspects have been provided, the recommendations may be analyzed and one or more operational aspects may be adjusted based on the analysis (Step 340). Management system 120 may analyze the recommendations according to the priority assigned by the one or more subscribers. For example, a higher priority recommendation may be given greater consideration than lower priority recommendation. In any cases where conflicting recommendations are received, the lower priority recommendation may be ignored.

Management system 120 may adjust one or more operational aspects associated with greenhouse gas project environment 100 based on the analysis. For example, in response to a high priority recommendation to increase greenhouse gas credit production, management system 120 may increase a productivity associated with one or more of greenhouse gas facilities 110a-c based on the recommendation.

Optionally, upon receiving recommendations for adjusting one or more operational aspects, one or more proposals regarding potential greenhouse gas opportunities may be provided based on the analysis of the operation data (Step 350). Potential greenhouse gas opportunities may include construction and operation of additional greenhouse gas facilities; purchase of greenhouse gas credits from a greenhouse gas credit trading market; purchase of landfill, agricultural, coal bed, or biomass land for future projects; and/or acquisition of one or more greenhouse gas emission sources that may qualify for greenhouse gas credits. According to one embodiment, development subscriber 143 associated with management system 120 may be configured to provide these proposals to a project manager, to management system 120 for further analysis, or to one or more other subscribers.

Once one or more proposals have been provided, a decision may be made as to whether or not to pursue one or more of the proposals based on operation data associated with one or more of greenhouse gas facilities 110a-c (Step 360). This decision may be based on a comparison of the operation data associated with the one or more greenhouse gas facilities with one or more characteristics associated with greenhouse gas project environment 100. Should the greenhouse gas facility be capable of meeting the project characteristics (Step 360: Yes), management system 120 may continue monitoring greenhouse gas project environment 100 without implementing a proposal. For example, a predicted increase in demand for greenhouse gas credits may be compared with the production capacity associated with greenhouse gas facilities 110a-c. Should the production capacity be capable of satisfying the increase in demand, management system 120 may elect not to pursue the proposals.

Alternatively, if one or more of greenhouse gas facilities 110a-c are unable to meet a project environment characteristic, recommendation, and/or requirement (Step 360: No), one or more of the proposals may be recommended and a report summarizing the one or more recommendations may be generated (Step 370). Following the above example, if the predicted increase in greenhouse gas credit demand exceeds a production capacity of one or more of greenhouse gas facilities 110a-c, one or more of the proposals may be recommended by management system 120 to accommodate the potential increase in demand. Additionally, a report may be generated and distributed to a subscriber summarizing the one or more proposals and their respective impacts (including potential costs/benefits) on greenhouse gas project environment 100.

### INDUSTRIAL APPLICABILITY

Although the disclosed systems and methods for project management have been described in association with greenhouse gas project environment 100, the system may be used to manage any project where efficient performance monitoring and adjustment may be required. Specifically, processes consistent with the disclosed embodiments may allow an organization to monitor and control operations and/or forecast potential opportunities and developments related to greenhouse gas environments based on real-time information associated with the project environment.

The presently disclosed greenhouse gas project management system 120 and method may have several advantages. For example, because management system 120 may be communicatively coupled to each facility and subscriber associated with greenhouse gas project environment 100, real-time operation data may be collected and distributed by management system 120. As a result, entities that rely on making real-time operational and business decisions may receive current, up-to-date information associated with the project environment.

The disclosed project management systems and methods may also improve reliability. For example, because information may be received from each facility directly, automatically, and in real-time, time lag and errors resulting from manual data entry may be reduced or eliminated. As a result, decisions and recommendations may be more reliable than conventional systems that require users to manually enter data into computer analysis tools. Furthermore, because management system 120 may be configured to monitor the real-time operation data and make operational adjustments to one or more greenhouse gas facilities 110a-c in real-time, performance problems may be easily and reliably corrected, without interference from an intermediary (e.g., user, project manager, etc.).

It will be apparent to those skilled in the art that various modifications and variations can be made to the disclosed greenhouse gas management system and associated method without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system for managing greenhouse gas related activities, comprising:
a management system communicatively coupled to a greenhouse gas facility and configured to collect and distribute operation data associated with operations of the greenhouse gas facility;
at least one subscriber communicatively coupled to the management system and configured to:
analyze the received operation data based on at least one characteristic of a greenhouse gas project environment; and
provide, to the management system, one or more recommendations for adjusting an operational aspect associated with the greenhouse gas facility based on the analysis; and
wherein the management system adjusts one or more operational aspects associated with the greenhouse gas facility based on the recommendations provided by the subscriber.

2. The system of claim 1, wherein the greenhouse gas facility is configured to:
collect a first greenhouse gas; and
convert the collected greenhouse gas into a second greenhouse gas and a conversion product, wherein the second greenhouse gas has a lower global warming potential than the first greenhouse gas; and
determine an amount of greenhouse gas credits generated by the conversion.

3. The system of claim 1, wherein the operation data includes data indicative of the quantity of greenhouse gas credits generated by the greenhouse gas facility.

4. The system of claim 3, wherein adjusting the operational aspect associated with the greenhouse gas project includes adjusting a greenhouse gas conversion rate associated with the greenhouse gas facility to cause an increase the production of greenhouse gas credits if the quantity of greenhouse gas credits is less than a target quantity of greenhouse gas credits.

5. The system of claim 3, wherein the operation data includes the quantity of the conversion product generated by the greenhouse gas facility.

6. The system of claim 5, wherein adjusting the operational aspect associated with the greenhouse gas project includes adjusting a greenhouse gas conversion rate associated with the greenhouse gas facility to cause an increase the production of the conversion product if the quantity of the conversion product is less than a target quantity of the conversion product.

7. The system of claim 3, wherein the subscriber includes an accounting system associated with the greenhouse gas project, the subscriber configured to monitor a balance of greenhouse gas credits generated by the greenhouse gas facility.

8. The system of claim 7, wherein the accounting system is further configured to:
receive an order for greenhouse gas credits;
allocate a quantity of greenhouse gas credits associated with the order; and
provide a notification to the management system if the allocated number of greenhouse gas credits causes the balance of greenhouse gas credits to fall below a threshold amount.

9. The system of claim 8, wherein the management system is further configured to adjust a greenhouse gas conversion rate associated with the greenhouse gas facility to cause an increase the production of the greenhouse gas credits in response to the notification.

10. The system of claim 1, wherein the subscriber includes an accounting system associated with the greenhouse gas project and configured to monitor a balance of the conversion product.

11. The system of claim 10, wherein the accounting system is further configured to:
receive an order for an amount of conversion product;
allocate the amount of conversion product associated with the order; and
provide a notification to the management system if the allocated amount of conversion product causes the balance of greenhouse gas credits to fall below a threshold amount.

12. The system of claim 8, wherein the management system is further configured to adjust a greenhouse gas conversion rate associated with the greenhouse gas facility to cause an increase the production of the conversion product in response to the notification.

13. The system of claim 1, wherein the subscriber includes a sales and marketing system configured to analyze current and historical trends in the price associated with greenhouse gas credits.

14. The system of claims 13, wherein the sales and marketing system is further configured to establish a sale price associated with the greenhouse gas credits based on the price trend analysis.

15. The system of claim 1, wherein the management system is further configured to:
analyze a greenhouse gas project environment based on the recommendations received from the subscriber and the received operation data associated with the greenhouse gas facility; and
generate a report indicative of a status of the greenhouse gas project environment.

16. The system of claim 15, wherein the report includes recommendations for a future development of greenhouse gas credit generating opportunities based on the project environment analysis.

17. A method for managing a greenhouse gas reduction project, comprising:
receiving operation data indicative of a performance of a greenhouse gas reduction project;
monitoring one or more characteristics associated with a greenhouse gas project environment;
analyzing the received operation data associated with the greenhouse gas reduction project based on the monitored characteristics;
providing recommendations for adjusting one or more operational aspects associated with the greenhouse gas reduction project based on the analysis; and
adjusting the one or more operational aspects associated with the greenhouse gas reduction project based on an analysis of the recommendations.

18. The method of claim 17, wherein monitoring one or more characteristics includes monitoring a balance of greenhouse gas credits associated with the greenhouse gas reduction project.

19. The method of claim 18, wherein adjusting one or more operational aspects associated with the greenhouse gas facility includes adjusting a greenhouse gas conversion rate associated with the greenhouse gas reduction project to cause an increase the production of greenhouse gas credits if the balance of greenhouse gas credits is below a threshold level.

20. The method of claim 17, wherein monitoring one or more characteristics includes monitoring a balance of a conversion product associated with the greenhouse gas reduction project.

21. The method of claim 20, wherein adjusting one or more operational aspects associated with the greenhouse gas facility includes adjusting a greenhouse gas conversion rate associated with the greenhouse gas reduction project to cause an increase the production of the conversion product if the balance of conversion product is below a threshold level.

22. The method of claim 17, wherein monitoring one or more characteristics includes monitoring one or more trends associated with a greenhouse gas credit trading market.

23. The method of claim 22, wherein the one or more trends includes at least one of price data, trade volume, or number of available credits.

24. The method of claim 22, wherein adjusting one or more operational aspects associated with the greenhouse gas facility includes adjusting a greenhouse gas conversion rate associated with the greenhouse gas reduction project to cause an increase the production of the conversion product based on the one or more trends.

25. The method of claim 17, wherein monitoring one or more characteristics includes monitoring one or more trends associated with a commodity trading market.

26. The method of claim 25, wherein the one or more trends includes at least one of price data, trade volume, supply, or demand.

27. The method of claim 25, wherein adjusting one or more operational aspects associated with the greenhouse gas facility includes adjusting a greenhouse gas conversion rate associated with the greenhouse gas reduction project to cause an increase the production of the conversion product based on the one or more trends.

28. The method of claim 17, wherein providing recommendations for adjusting one or more operational aspects associated with a greenhouse gas reduction project includes providing a report summarizing one or more potential greenhouse gas opportunities based on the operation data.

29. The method of claim 28, wherein providing recommendations for adjusting one or more operational aspects associated with a greenhouse gas reduction project further includes:
analyzing the recommendations with respect to the operation data;
determining whether the capacity of the greenhouse gas project satisfies one or more of the recommendations; and
recommending one or more of the potential greenhouse gas opportunities based on the determination.

30. A greenhouse gas project environment comprising:
one or more greenhouse gas facilities, each greenhouse gas facility configured to:
collect a first greenhouse gas; and
convert the collected greenhouse gas into a second greenhouse gas and a conversion product, wherein the second greenhouse gas has a lower global warming potential than the first greenhouse gas; and
determine an amount of greenhouse gas credits based on a global warming potential reduction associated with the conversion;
a management system operatively coupled to each of the one or more greenhouse gas facilities and configured to:
collect operation data associated with the performance of each of the one or more greenhouse gas facilities;
monitor one or more characteristics associated with the greenhouse gas project environment;
analyze the collected operation data based on the one or more characteristics; and
adjust an operational aspect associated with one or more of the greenhouse gas facilities based on the analysis.

31. The environment of claim 30, wherein the one or more characteristics includes a predicted price increase associated with a greenhouse gas credit trading market and the adjusting includes causing an increase in the conversion rate associated with one or more of the greenhouse gas facilities in response to the predicted increase.

32. The environment of claim 30, wherein the one or more characteristics includes a balance of greenhouse gas credits associated with the greenhouse gas project environment and the adjusting includes causing an increase in the conversion rate associated with one or more of the greenhouse gas facilities is the balance of greenhouse gas credits drops below a threshold amount.

33. The environment of claim 30, wherein the management system is further configured to:
monitor a production capacity associated with each of the one or more greenhouse gas facilities; and
generate a report summarizing a status associated with the greenhouse gas project environment based on the received operation data, the monitored production capacity associated with one or more greenhouse gas facilities, and one or more characteristics associated with the greenhouse gas project environment.

34. The environment of claim 33, wherein the report includes one or more recommendations for the construction and operation of future greenhouse gas facilities.

35. A greenhouse gas project management system comprising:
an interface;
a central processing unit communicatively coupled to the interface and configured to:
receive, via the interface, operation data associated with a performance of one or more greenhouse gas facilities;
monitor one or more characteristics associated with a greenhouse gas project environment;
analyze the collected operation data based on the one or more characteristics; and
adjust an operational aspect associated with one or more of the greenhouse gas facilities based on the analysis.

36. The system of claim 35, wherein the one or more characteristics includes a predicted price increase associated with a greenhouse gas credit trading market and the adjusting includes causing an increase in the conversion rate associated with one or more of the greenhouse gas facilities in response to the predicted increase.

37. The system of claim 35, wherein the one or more characteristics includes a balance of greenhouse gas credits associated with the greenhouse gas project environment and the adjusting includes causing an increase in the conversion rate associated with one or more of the greenhouse gas facilities is the balance of greenhouse gas credits drops below a threshold amount.
